(19) United States
(12) Patent Application Publication
(10) Pub. No.: US 2020/0300655 A1
(43) Pub. Date: Sep. 24, 2020

(54) VEHICLE CONTROL CIRCUIT, VEHICLE, AND DATA INPUT/OUTPUT METHOD

(71) Applicant: PANASONIC INTELLECTUAL PROPERTY MANAGEMENT CO., LTD., Osaka (JP)

(72) Inventors: Akira MASUO, Kanagawa (JP); Tetsuo MATSUSE, Osaka (JP)

(73) Assignee: PANASONIC INTELLECTUAL PROPERTY MANAGEMENT CO., LTD., Osaka (JP)

(21) Appl. No.: 16/821,672

(22) Filed: Mar. 17, 2020

(30) Foreign Application Priority Data
Mar. 22, 2019 (JP) 2019-055278

(51) Int. Cl. G01C 21/36; G06N 5/04; B60K 35/00; G01C 21/34; G06Q 30/06; G06Q 20/12

(52) U.S. Cl. CPC G01C 21/3679; G06N 5/04; B60K 35/00; G01C 21/3605; G06N 20/00; G01C 21/3629; G01C 21/3667; G06Q 30/0631; G06Q 20/12; G01C 21/3476

(57) ABSTRACT

A vehicle control circuit is mountable on a vehicle on which a driver rides. The vehicle control circuit is configured to: receive an input of a detection result of a state of the driver during driving from at least one sensor, the sensor being mounted on the vehicle and configured to detect the state; output recommendation data to a notification device mounted on the vehicle, the recommendation data relating to use of a product or service for improving the state of the driver during driving indicated by the detection result; perform settlement processing for the use of the corresponding product or service in accordance with an input from the driver in response to the recommendation data; and provide a route to a destination of the use of the product or service based on completion of the settlement processing via the notification device.

### FIELD

The present disclosure relates to a vehicle control circuit, a vehicle, and a data input/output method.

### BACKGROUND

JP-A-2015-127885 discloses a technology for providing service to a customer by performing processing of distribution of news for a customer, ordering, visit to a store, and customer service in order to streamline the business activity of a restaurant. In the distribution of news for a customer, news for a customer with coupons describing the contents of the store's sales promotion campaign is distributed from a store terminal to a customer terminal via an ordering support server device and displayed on the customer terminal. In ordering, an order input process is performed on an order screen displayed on the customer terminal by operation of a customer who understands the content of the news for the customer and the order input information is transmitted to the store terminal of the order destination via the ordering support server device. When there is a response from the store terminal to accept the order, the order information is sent to the customer terminal via the ordering support server device and displayed on the customer terminal. At the store, a customer who arrives at the desired date and time of receipt displays the two-dimensional barcode in the order information on the customer terminal and presents it to a store staff. In the customer service, the two-dimensional barcode is photographed by a camera at the store terminal and a corresponding order confirmation screen is displayed. When the store staff confirms that the payment has been completed via the order confirmation screen, the ordered product is delivered to the customer. The store terminal sends a transaction completion notification to the ordering support server device.

### SUMMARY

However, the technology disclosed in JP-A-2015-127885 assumes that a customer performs an operation while looking at an order screen displayed on the customer terminal when performing an order input process. For this reason, for example, to improve the convenience of a driver while driving, when the technology disclosed in this document is applied to the order processing support of a product performed by a driver to the customer terminal (for example, a vehicle-mounted device such as a car navigation device or a smartphone possessed by the driver), it is possible for the driver to look away from the front of a vehicle, even temporarily, during the ordering phase. For this reason, there is a problem that safe driving of the driver may be hindered.

The present disclosure has been devised in view of the above-described circumstances of the related art and an object thereof is to provide a vehicle control circuit, a vehicle, and a data input/output method which efficiently perform processing necessary for using a product or service to adaptively improve the driver's state without hindering the driver's safe driving and improve the convenience of the driver while driving.

In the present disclosure, there is provided a vehicle control circuit mountable on a vehicle on which a driver rides, the vehicle control circuit including: an input unit configured to receive an input of a detection result of a state of the driver during driving from at least one sensor, the sensor being mounted on the vehicle and configured to detect the state; a recommendation processing unit configured to output recommendation data to a notification device mounted on the vehicle, the recommendation data relating to use of a product or service for improving the state of the driver during driving indicated by the detection result; a settlement processing unit configured to perform settlement processing for the use of the corresponding product or service in accordance with an input from the driver in response to the recommendation data; and a guidance processing unit configured to provide a route to a destination of the use of the product or service based on completion of the settlement processing via the notification device.

In the present disclosure, there is provided a vehicle including: a vehicle control circuit; at least one sensor for detecting a state of a driver during driving; and a notification device, wherein the vehicle control circuit includes: an input unit configured to receive an input of a detection result of the state from the sensor, a recommendation processing unit configured to output recommendation data to the notification device, the recommendation data relating to use of a product or service for improving the state of the driver during driving indicated by the detection result, a settlement processing unit configured to perform settlement processing for the use of the corresponding product or service in accordance with an input from the driver in response to the recommendation data, and a guidance processing unit configured to provide a route to a destination of the use of the product or service based on completion of the settlement processing via the notification device.

In the present disclosure, there is provided a data input/output method which is executed by a vehicle control circuit mountable on a vehicle on which a driver rides, the data input/output method including: receiving an input of a detection result of a state of the driver during driving from at least one sensor, the sensor being mounted on the vehicle and configured to detect the state; outputting recommendation data to a notification device mounted on the vehicle, the recommendation data relating to use of a product or service for improving the state of the driver during driving indicated by the detection result; performing settlement processing for the use of the corresponding product or service in accordance with an input from the driver in response to the recommendation data; and providing a route to a destination of the use of the product or service based on completion of the settlement processing via the notification device.

According to the present disclosure, the process necessary for using the product or service for adaptively improving the driver's state can be efficiently performed without hindering the driver's safe driving and the driver's convenience during driving can be improved.

### BRIEF DESCRIPTION OF DRAWINGS

FIG. 1 is a diagram illustrating a system configuration example of a vehicle control system including a vehicle equipped with a vehicle control circuit according to a first embodiment;

FIG. 2 is a diagram illustrating an example of a state inside a vehicle compartment in a front side of the vehicle equipped with the vehicle control circuit;

FIG. 3 is a diagram illustrating an example of registered contents of a recommendation table;

FIG. 4 is a diagram illustrating an example of registered contents of a purchase history table;

FIG. 5 is a flowchart illustrating an example of an operation procedure of the vehicle control circuit according to the first embodiment;

FIG. 6 is a diagram illustrating an example of an image displayed by a display circuit mounted on the vehicle according to the first embodiment and an example of sound output from a speaker mounted on the vehicle; and

FIG. 7 is a diagram schematically illustrating an example of a traveling route on which the vehicle according to the first embodiment travels.

### DETAILED DESCRIPTION

Hereinafter, an embodiment that specifically discloses the configuration and operation of a vehicle control circuit, a vehicle, and a data input/output method according to the present disclosure will be described in detail with reference to the drawings as appropriate. However, unnecessary detailed descriptions may be omitted. For example, a detailed description of a well-known item or a redundant description of substantially the same configuration may be omitted. This is to prevent the following description from being unnecessarily redundant and to facilitate understanding by those skilled in the art. The accompanying drawings and the following description are provided to enable those skilled in the art to fully understand the present disclosure and are not intended to limit the claimed subject matter.

### Overview of First Embodiment

In a first embodiment, a vehicle control circuit mounted in a vehicle detects a state of a physical condition (for example, drowsiness, high emotion, poor physical condition (for example, cold, cough), and the like) of a driver who is riding a vehicle. Based on the detection result, the vehicle control circuit specifies an appropriate product or service to improve the driver's state indicated by the detection result and recommends the product or service to the driver. When the vehicle control circuit detects an approval operation (for example, an operation of ordering the recommended product by the driver) of the driver, the vehicle control circuit guides the driver to a settlement process regarding the order of the product and a route to a store where the product can be received. In this way, drivers can easily receive products which can improve their states with simple operations without turning their eyes even when driving, so the vehicle control circuit can effectively assist the driver in safe driving.

When the driver is drowsy, an example of a product for improving a driver's state is coffee or energy drink, which is a caffeinated beverage. When the driver has a poor physical condition (for example, having a cold, cough, and the like), a cold medicine for suppressing a cold or cough may be used. When the driver's emotions are high, gum or soft drinks can be exemplified.

As an example of a service for improving the driver's state, when the driver is drowsy, parking in a parking lot where the vehicle can be stopped and the driver can have a break can be exemplified. When the driver has a poor physical condition (see above), introduction of hospitals where the driver can be consulted immediately may be exemplified. When the driver's emotions are high, massage with high relaxation effect may be exemplified.

It goes without saying that the product or service for improving the state of the driver is not limited to the examples described above.

Configuration of Vehicle Control System

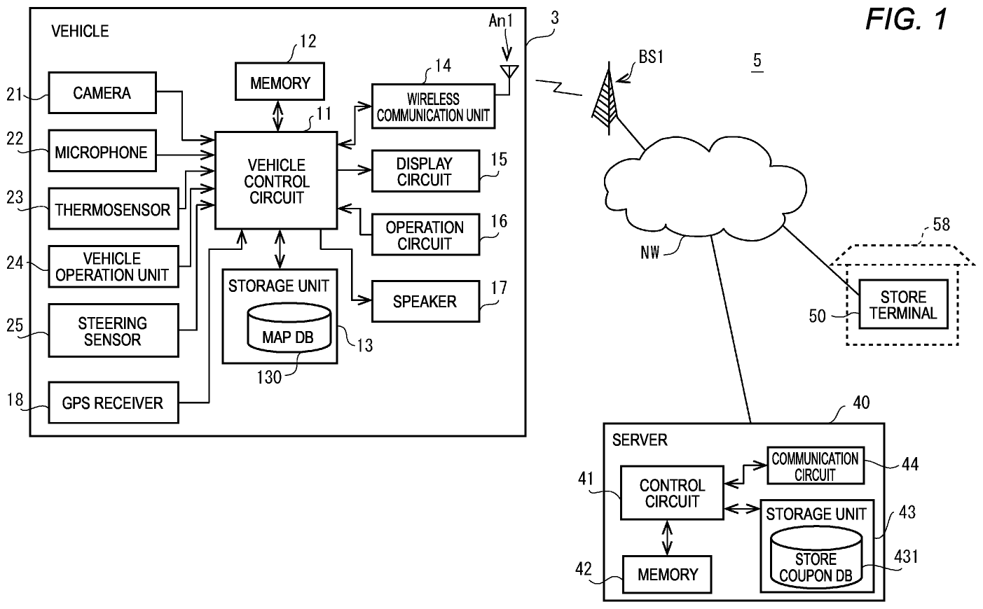

FIG. 1 is a diagram illustrating a system configuration example of a vehicle control system 5 including a vehicle 3 on which a vehicle control circuit 11 according to the first embodiment is mounted. The vehicle control system 5 includes the vehicle 3, a server 40, and a store terminal 50. The vehicle 3, the server 40, and the store terminal 50 are mutually connected via a network NW.

The vehicle 3 includes the vehicle control circuit 11, a memory 12, a storage unit 13, a wireless communication circuit 14 to which an antenna An1 is connected, a display circuit 15, an operation circuit 16, a speaker 17, and a GPS receiver 18.

The vehicle control circuit 11 is configured by, for example, an electronic control unit (ECU). The vehicle control circuit 11 detects the state of the driver's physical condition based on detection outputs from various sensors (see below) mounted in the vehicle 3. The vehicle control circuit 11 recommends a product (for example, coffee for awakening drowsiness) for improving the driver's state when, for example, a detection output indicating that the driver is drowsy is acquired from the sensor.

The ECU which configures the vehicle control circuit 11 is specifically configured using one or more processors and comprehensively controls the operation of each unit of the vehicle 3. The vehicle control circuit 11 reads out the processing program stored in the memory 12 from the memory 12 and executes it, in such a manner that the vehicle control circuit 11 specifically implements and executes various functions. The processor includes, for example, a micro processing unit (MPU), a central processing unit (CPU), a digital signal processor (DSP), a graphical processing unit (GPU), and the like.

The processor associates the driver's face image captured by a camera 21 in advance and the driver's voice picked up by a microphone 22 with each state of the driver's physical conditions and stores them in the storage unit 13. The storage unit 13 stores and holds a template of a face image for each driver state prepared in advance to correspond to various states of the driver. The processor determines the state of the driver's physical condition based on the similarity between the face image corresponding to the template and the face image actually captured by the camera 21.

The processor may perform machine learning such as deep learning in advance as teacher data in which the driver's face image or driver's voice and the driver's state stored in the storage unit 13 are associated with each other. Then, the processor may optimize the weighting coefficient of the neurons used for each of the input layer, the intermediate layer, and the output layer of the neural network to generate a trained model used as artificial intelligence. The processor may detect (specify) the state of the driver by inputting either the image captured by the camera 21 or audio data collected by the microphone 22 to the learned model.

The processor may similarly perform machine learning such as deep learning in advance as teacher data in which the state of the driver is associated with a product or service for improving the state of the driver and may generate a trained model. The processor may input the state of the driver to the trained model and identify a product or service suitable for the state of the driver. When using artificial intelligence, the processor (in other words, the vehicle control circuit 11) can generate a trained model optimized for the driver in the vehicle compartment and can detect a state and recommend a recommended product or service specific to the driver.

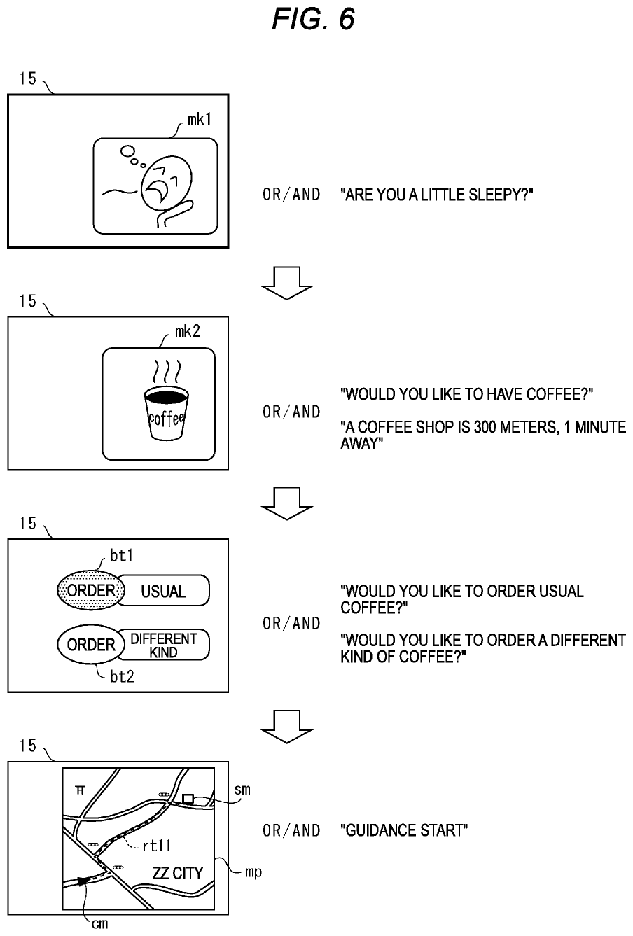

The memory 12 is configured using, for example, a random access memory (RAM) and a read only memory (ROM) and temporarily stores a program necessary for executing the operation of the vehicle 3 and data or information generated during the operation. The RAM is a work memory used when the vehicle control circuit 11 operates, for example. The ROM stores, for example, a program for controlling the vehicle control circuit 11 in advance. The memory 12 stores an image (for example, a sleepiness mark indicating a drowsiness state) such as an icon for indicating the state of the driver and an image (for example, various drawing data such as a coffee mark) of a product or the like for improving the state of the driver is stored. The memory 12 stores various types of voice data which are synthesized in advance for voice output from the speaker 17, which will be described below in detail with reference to FIG. 6. The memory 12 stores information (for example, an individual name, a credit card number, and an expiration date posted on a credit card of the driver) necessary for a payment process unique to the driver and the like.

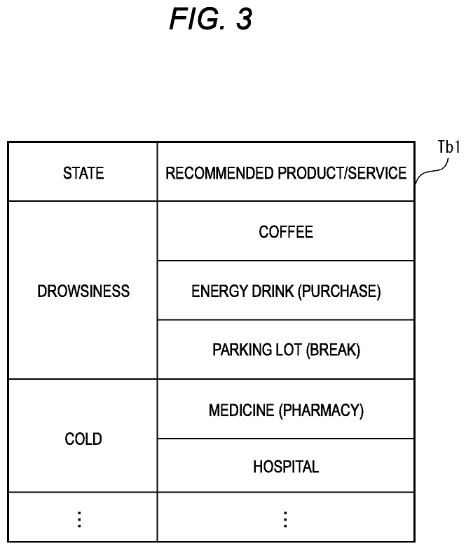

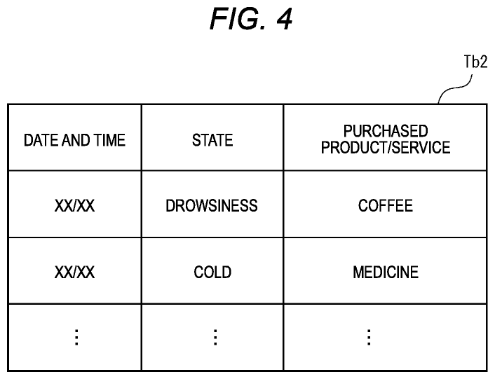

The storage unit 13 includes a secondary storage device (for example, a hard disk drive (HDD) or a solid state drive (SSD)) and a tertiary storage device (for example, an optical disk or an SD card). The storage unit 13 includes a map database 130 for storing information on roads on which the vehicle 3 travels and map data having map information. In FIG. 1, the database is abbreviated as “DB” for convenience. The map data may be acquired in the latest state from the server 40 in which the vehicle control circuit 11 is connected to the network NW via the wireless communication circuit 14 or may be map data stored in the map database 130 in advance. The storage unit 13 stores a recommendation table Tb1 (see FIG. 3) in which information on various products or services recommended according to the state of the driver is registered. The storage unit 13 stores a purchase history table Tb2 (see FIG. 4) in which purchase histories of products or services that the driver has settled (that is, purchased) in the past are registered. The storage unit 13 stores the feature amount of the face image or the feature amount of the voice used for the personal authentication of the driver.

The wireless communication circuit 14 performs wireless communication with the server 40 or the store terminal 50 connected to the network NW via the antenna An1 for wireless communication and a wireless base station BS1 provided by cellular or the like. That is, the wireless communication circuit 14 can perform wireless communication of data or information with the server 40 or the store terminal 50 by wireless communication. Here, the network NW may include a wide area communication network such as a local area network (LAN), a wide area network (WAN), a mobile network, a power line communication network, and the Internet.

The display circuit 15 as an example of a notification device is configured by a display device such as a liquid crystal display device or an organic electroluminescence (EL) device. The display circuit 15 may be a single display device, a car navigation device, or a display unit for display audio.

The operation circuit 16 is a touch panel on which each occupant including the driver can perform a touch operation. The operation circuit 16 is not limited to the touch panel and may include input devices such as a mouse, a keyboard, and a touchpad. The touch panel may be an interface device in which an operation circuit and a display circuit are integrated.

The speaker 17 acoustically outputs, for example, sound in an audible sound range (a frequency band of 20 Hz to 20 kHz). The speaker 17 may be a condenser speaker or a diaphragm speaker. The speaker may be a directional speaker excellent in directivity or may be a non-directional speaker.

The global positioning system (GPS) receiver 18 includes a GPS antenna and receives signals transmitted from GPS satellites and quasi-zenith satellites. The GPS receiver 18 constantly obtains current position information of the vehicle 3 while the ignition of the vehicle 3 is turned on and outputs the current position information to the vehicle control circuit 11.

The vehicle 3 includes the camera 21, the microphone 22, a thermosensor 23, a vehicle operation unit 24, and a steering sensor 25.

The camera 21 as an example of a sensor mounted in the vehicle 3 includes a solid-state imaging device such as charged coupled devices (CCD) or a complementary metal-oxide-semiconductor (CMOS). The camera 21 forms light rays emitted from a subject on an imaging surface, converts the formed optical image into an electric signal, and outputs a video signal. The camera 21 outputs image data of a captured image of the driver to the vehicle control circuit 11. The camera 21 may perform predetermined image processing on the captured image of the driver and determine that the driver is in a drowsiness state based on, for example, the face image of the driver, and then the camera 21 may output a determination result (that is, information indicating that the driver is in a drowsiness state) to the vehicle control circuit 11 together with the captured image of the driver. In this case, the camera 21 may hold a template of the driver's face image and determine the drowsiness of the driver based on the similarity between the template and the captured face image. The camera 21 also determines the drowsiness state of the driver based on the input face image using a trained model in which the face image in which the driver is in a drowsy state is learned by machine learning such as deep learning.

The microphone 22 as an example of a sensor mounted in the vehicle 3 collects a voice emitted by the driver and outputs voice data of the collected voice to the vehicle control circuit 11. The microphone 22 is formed of, for example, a directional microphone having directivity directed to a direction near the driver's face. The microphone 22 may be a single high-quality small electret condenser microphone (ECM) or a microphone array formed of a plurality of ECMs.

The vehicle control circuit 11 can determine, for example, whether the driver is drowsy based on the voice collected by the microphone 22. The microphone 22 picks up the voice of “Oh, sleepy” that is emitted when yawning and the sound of snoring “goo, goo” that is emitted when the driver goes to sleep momentarily. Even when an occupant other than the driver is drowsy, the drowsiness may be transmitted to the driver. Therefore, the microphone 22 may pick up the sound of another occupant during sleepiness. In this case, the microphone 22 may be an omnidirectional microphone. The microphone 22 may perform voice recognition on the voice emitted by the driver and output the voice recognition result to the vehicle control circuit 11. For example, it is assumed that the driver makes a voice input using the microphone 22 in response to various inquiries and button operations displayed on the display circuit 15 of the vehicle control circuit 11.

The thermosensor 23 as an example of a sensor mounted in the vehicle 3 senses infrared light emitted from the driver's face or the like and detects the driver's body temperature based on the color of the infrared light. The thermosensor 23 outputs the detection result of the driver's body temperature to the vehicle control circuit 11. The detection result of the driver's body temperature is used when the vehicle control circuit 11 determines the driver's state.

The vehicle operation unit 24 as an example of a sensor mounted in the vehicle 3 includes, for example, an accelerator pedal, a brake pedal, a turn signal, and the like. The depression amount of the accelerator pedal, the presence of the brake operation, and the state of the turn signal switch are input to the vehicle control circuit 11 and are used in determining the state of the driver.

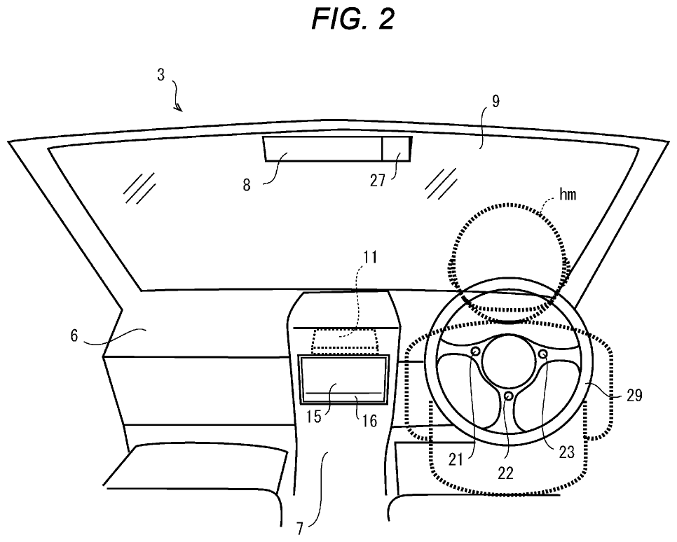

The steering sensor 25 as an example of a sensor mounted in the vehicle 3 detects a steering angle of a steering 29 (see FIG. 2) and outputs the detected steering angle to the vehicle control circuit 11. The vehicle control circuit 11 detects changes in the steering angle and the steering angular velocity and determines the state of the driver based on the presence of a staggered driving due to an abrupt steering or unstable steering, which is considered to be caused by, for example, drowsiness or cold.

The server 40 is configured using a high-performance computer device and includes a control circuit 41, a memory 42, a storage unit 43, and a communication circuit 44. The server 40 provides a coupon stored in a store coupon database 431 when sending a coupon that can be used in a store (for example, a coffee shop 58) to the vehicle 3 via the network NW. When the coupon of the store near the current location of the vehicle 3 is not stored in the store coupon database 431, the server 40 may inquire the store terminal 50 via the network NW to obtain the coupon each time and send the coupon to the vehicle 3.

The server 40 communicates with the vehicle 3 via the network NW. Then, in response to a request from the vehicle 3, the server 40 specifies, in addition to the coupon, information of stores such as a coffee shop or a pharmacy located near the current location of the vehicle 3 by using the map data stored in the storage unit 13, and then teaching.

The control circuit 41 is configured by, for example, a processor. The control circuit 41 generally controls the operation of each unit of the server 40. The control circuit 41 specifically realizes and executes various functions by, for example, the processor reading a processing program stored in the memory 42 from the memory 42 and executing the program. The processor includes, for example, an MPU, a CPU, a DSP, a GPU, and the like.

The memory 42 is configured by using, for example, a RAM and a ROM and temporarily stores a program necessary for executing the operation of the server 40, and data or information generated during the operation. The RAM is a work memory used when the control circuit 41 operates, for example. The ROM stores, for example, a program for controlling the control circuit 41 in advance.

The storage unit 43 is configured by a secondary storage device (for example, a hard disk drive (HDD) or a solid state drive (SSD)). The storage unit 43 includes the store coupon database 431 in which coupons available in each store are registered for each store.

The communication circuit 44 wirelessly communicates data or information with the vehicle 3 connected via the network NW and the wireless base station BS1 and the store terminal 50 connected via the network NW.

The store terminal 50 is an information processing terminal such as a personal computer (PC) installed in a store such as the coffee shop 58 or a pharmacy. The store terminal 50 performs a predetermined settlement process with the vehicle 3 on which the driver is riding when an order for using a product or service is received from the vehicle 3 connected via the network NW and the wireless base station BS1.

FIG. 2 is a diagram illustrating an example of a state inside a vehicle compartment in a front side of the vehicle 3 equipped with the vehicle control circuit 11. In the vehicle compartment, various sensors and the like for detecting the state of a driver hm who is driving forward looking through the windshield 9 are arranged.

The camera 21, the microphone 22, and the thermosensor 23 are arranged on a rim portion of the steering 29 near the shaft. The camera 21 captures an image near the face of the driver hm. The microphone 22 picks up a sound emitted by the driver hm. The thermosensor 23 detects body temperature near the face of the driver hm. The steering sensor 25 (see FIG. 1) for detecting the steering angle of the steering wheel operated by the driver hm is arranged inside the shaft column of the steering 29.

The vehicle control circuit 11 is built in an upper portion of the center console 7 which separates the driver's seat and the passenger's seat near a dashboard 6. The display circuit 15 which can display various images and the operation circuit 16 which receives the operation of the driver hm, which are included in the vehicle control circuit 11, are installed to be exposed above the center console 7. In the vicinity of a rearview mirror 8 mounted on the upper part of the windshield 9, a drive recorder 27 capable of imaging the front and rear of the vehicle 3 is arranged.

FIG. 3 is a diagram illustrating an example of registered contents of the recommendation table Tb1. In the recommendation table Tb1, information (for example, name, destination of the product or service) on a product or service for improving the state of the driver corresponding to the state of the driver is registered in advance. For example, when the driver is drowsy, coffee which is expected to wake up when drinking is registered. Information about a plurality of stores which provide coffee may be registered. There are registered energy drinks which are expected to make a person feel better. Information about a plurality of stores which sell energy drinks may be registered. Information (for example, name, position information) on the parking lot where the driver can take a nap after taking a break is registered.

FIG. 4 is a diagram illustrating an example of registered contents of the purchase history table Tb2. The purchase history table Tb2 registers and updates the purchase history of products or services which are purchased or used by the driver during past driving. The purchase history includes the date and time of purchase, the state of the driver, and information on the purchased product or the used service. As an example, histories such as “XX/XX drowsiness coffee”, “XX/XX cold medicine” and the like are registered.

Operation of Vehicle Control System

Next, an operation procedure of the vehicle control circuit 11 of the vehicle 3 according to the first embodiment will be described.

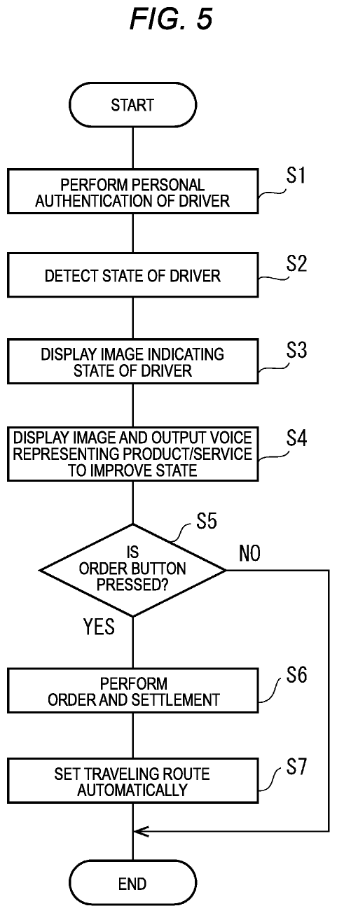

FIG. 5 is a flowchart illustrating an example of an operation procedure of the vehicle control circuit 11 according to the first embodiment. When the driver hm turns on the ignition after getting on the vehicle 3, the vehicle control circuit 11 mounted on the vehicle 3 starts the operation (processing) illustrated in FIG. 5.

In FIG. 5, the vehicle control circuit 11 inputs a face image of the driver hm captured by the camera 21. The vehicle control circuit 11 inputs the voice of the driver hm collected by the microphone 22. The vehicle control circuit 11 performs personal authentication of the driver based on the input face image and voice (S1).

The vehicle control circuit 11 compares the feature amount of the face image of the driver hm stored in the storage unit 13 with the feature amount of the input face image and determines whether the similarity is within a predetermined threshold value (specifically, a threshold value used for determining the feature amount of the face image). The vehicle control circuit 11 compares the feature amount of the voice of the driver hm registered in the storage unit 13 with the feature amount of the input voice and determines whether the similarity is within a predetermined threshold value (specifically, a threshold value used for determining the feature value of the voice). When the result of the determination based on the face image and the sound indicates that both similarities are within the corresponding threshold values, the vehicle control circuit 11 determines the approval (OK) as a result of the personal authentication.

When it is determined that the personal authentication result is OK, the vehicle control circuit 11 detects the state of the driver hm (S2). Here, as an example, a state where the driver is drowsy is illustrated, but it is needless to say that the invention is not limited to this state. When the face image captured by the camera 21 includes, for example, an image in which the driver opens his or her mouth widely and yawns or the driver's eyes remain half-open, the vehicle control circuit 11 determines that the driver hm is drowsy. When the voice collected by the microphone 22 includes, for example, the voice of “Oh, sleepy” or a snoring sound of “goo, goo” emitted when the driver goes to sleep momentarily, the vehicle control circuit 11 determines that the driver hm is drowsy.

The vehicle control circuit 11 may determine that the driver hm is drowsy when the steering angle detected by the steering sensor 25 indicates a change that appears during drowsiness. As an example of the state of the driver hm other than sleepiness, for example, when the body temperature of the driver hm detected by the thermosensor 23 is as high as 38° C., the vehicle control circuit 11 may determine that the driver hm has a slight cold and high heat.

When the driver is in a state of sleepiness, the vehicle control circuit 11 displays an image (for example, an icon) indicating the driver's state on the display circuit 15 (S3). The vehicle control circuit 11 outputs a predetermined sound (in other words, an announcement sound for notification to the driver) indicating the state of the driver from the speaker 17.

FIG. 6 is a diagram illustrating an example of an image displayed by the display circuit 15 mounted on the vehicle 3 according to the first embodiment and an example of sound output from the speaker 17 mounted on the vehicle 3. The display circuit 15 displays a drowsiness mark mk1 as an image representing a state in which the driver is drowsy. The drowsiness mark mk1 is an image imitating the face of a sleepy person. The speaker 17 outputs a voice message of “Are you a little sleepy?” as a voice indicating that the driver is drowsy.

The vehicle control circuit 11 displays on the display circuit 15 an image representing the product or service that is a measure to improve the driver's state (S4). The vehicle control circuit 11 causes the speaker 17 to output a sound indicating a measure for improving the driver's state. The display circuit 15 displays a coffee mark mk2 representing coffee having an awakening effect as an image representing a measure for improving the driver's state. The speaker 17 outputs a voice message “Would you like to have coffee?” as a voice representing a measure to improve the driver's state. The speaker 17 may output a voice message “A coffee shop is 300 meters, 1 minute away”. In this case, the vehicle control circuit 11 predicts an approximate distance and an arrival time based on information on the current position of the vehicle 3 and the position of the coffee shop obtained by the GPS receiver 18.

The vehicle control circuit 11 displays a coffee order screen on the display circuit 15. On this order screen, a “usual” order button bt1 and a “different kind” order button bt2 which can be operated by the driver hm are arranged. The “usual” order button bt1 is a button for selecting the same type of coffee that has been purchased in the past or that is frequently purchased, based on the purchase history table Tb2 of the driver hm. The “different kind” order button bt2 is a button for selecting a recommended type of coffee that has not been purchased in the past or that is purchased less frequently, based on the recommendation table Tb1. The “usual” order button bt1 is highlighted, for example, with the background color being yellow (dots in the drawing) and the character color being black for the text “order”. On the other hand, the “different kind” order button bt2 is displayed inconspicuously with the background color being white and the character color being gray. As described above, the vehicle control circuit 11 preferentially displays the product registered in the purchase history table Tb2 over the product registered in the recommendation table Tb1. There are various modes of preferential display, such as changing the size of characters. Here, the vehicle control circuit 11 simultaneously displays the product registered in the recommendation table Tb1 and the product registered in the purchase history table Tb2. When the product registered in the purchase history table Tb2 is displayed first and an order is not placed immediately, the vehicle control circuit 11 additionally displays the product registered in the recommendation table Tb1 later, in such a manner that the vehicle control circuit 11 may preferentially display the product registered in the purchase history table Tb2.

The vehicle control circuit 11 outputs a voice message of “Would you like to order usual coffee?” from the speaker 17, and then outputs a voice message of “Would you like to order a different kind of coffee?”. As described above, the vehicle control circuit 11 outputs the product registered in the purchase history table Tb2 by the voice message first and outputs the product registered in the recommendation table Tb1 by the voice message later, in such a manner that the vehicle control circuit 11 may preferentially output the product registered in the purchase history table Tb2 by the voice message. There are various modes in which it is preferentially output by the voice message. For example, the vehicle control circuit 11 may cause the speaker 17 to output the product registered in the purchase history table Tb2 at a higher volume than the product registered in the recommendation table Tb1. In other words, the speaker 17 outputs the voice message of “Would you like to order usual coffee?” at a high volume and outputs the voice message of “Would you like to order a different kind of coffee?” at a low volume.

The vehicle control circuit 11 determines whether the driver has been prompted by the screen display and the voice output to make a selection for obtaining coffee on the operation circuit 16, that is, whether the “usual” order button bt1 or the “different kind” order button bt2 has been pressed (S5). When the driver hm does not make a selection to get coffee, the vehicle control circuit 11 ends the processing as it is.

When the driver hm makes a selection to obtain coffee via the operation circuit 16 in Step S5, the vehicle control circuit 11 orders coffee from the coffee shop and performs settlement for buying the coffee (S6). The settlement is made automatically at the same time as the order. The vehicle control circuit 11 may perform settlement using a settlement agency that specializes in settlement services. The settlement agency can deal with various settlements such as credit card settlement, convenience store settlement, carrier settlement, and electronic money. The vehicle control circuit 11 may perform a credit settlement directly with a credit card company. When performing a credit settlement, the vehicle control circuit 11 transmits data of a credit number, an expiration date, a name, and a security code via the wireless communication circuit 14. In a case of a store where service has been started in recent years and bar code payment is possible, the vehicle control circuit 11 activates a code payment application. The code payment application generates code information including cash payment corresponding to the ordered coffee and transmits the code information to the store. In this case, the store terminal 50 receives the code information and confirms payment to the settlement institution. The vehicle control circuit 11 may receive the code information sent from the store at the same time as receiving the coffee order via the wireless communication circuit 14 and use the information to request the settlement institution to transfer money. As another settlement, the vehicle control circuit 11 may perform settlement by remitting virtual currency to the store.

When the settlement is completed, the vehicle control circuit 11 registers the history of the information (date and time, type of coffee, state) on the coffee purchased this time in the purchase history table Tb2 of the driver hm.

As described above, when the driver hm presses the “usual” order button bt1 to order the same coffee as usual, the settlement of the order is automatically performed. The operation of the driver hm is simple with only single action. Therefore, the driver hm can perform safe driving without hindering the driving operation.

When the settlement is completed, the vehicle control circuit 11 automatically sets a traveling route to a shop selling coffee (S7). In the automatic setting of the traveling route, the vehicle control circuit 11 acquires the current position of the vehicle 3 obtained by the GPS receiver 18. The vehicle control circuit 11 reads map data including the current position of the vehicle 3 and the position of the coffee shop from the map database 130 of the storage unit 13. The vehicle control circuit 11 sets an optimal traveling route from the current position of the vehicle 3 to the position of the coffee shop on the map data. The vehicle control circuit 11 generates screen data in which the current position of the vehicle 3, the traveling route to the coffee shop, the distance, the arrival time, and the navigation are superimposed on the map data image and the screen data is displayed on the display circuit 15. On the map mp displayed on the display circuit 15, an image in which a vehicle mark cm indicating the current position of the vehicle 3 is guided along a traveling route rt11 to a store mark sm indicating a coffee shop is superimposed.

The vehicle control circuit 11 outputs a navigation guide for guiding the vehicle 3 along the traveling route to the coffee shop from the speaker 17 by voice. At the start of the navigation, the speaker 17 outputs the voice message of “Guidance start”.

In FIG. 6, the information to be notified to the driver hm is both the image displayed by the display circuit 15 and the sound output by the speaker 17. However, either the image displayed by the display circuit 15 or the sound output by the speaker 17 may be used. The driver hm may select either the image displayed by the display circuit 15 or the sound output by the speaker 17.

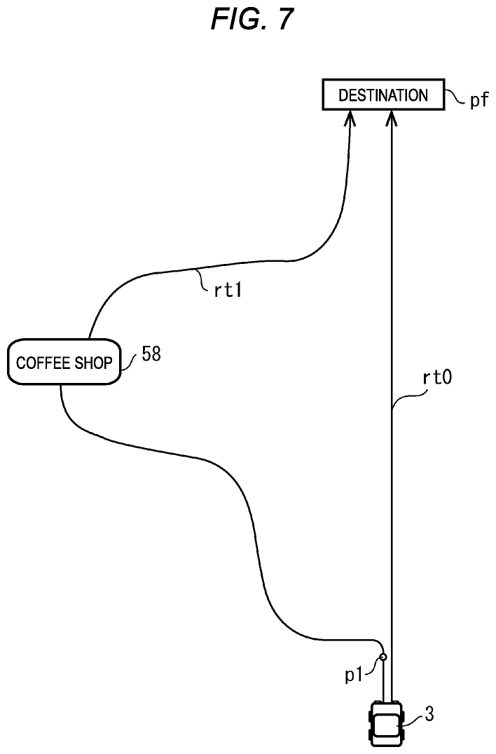

FIG. 7 is a diagram schematically illustrating an example of a traveling route on which the vehicle 3 according to the first embodiment travels. It is assumed that the vehicle 3 driven by the driver hm is traveling toward a destination pf along the traveling route rt0. When the drowsiness of the driver hm is detected by the vehicle control circuit 11 at a position p1 during traveling, the vehicle control circuit 11 changes the traveling route to a detour route rt1 such as to stop at the coffee shop 58 according to the guidance of the navigation.

When the vehicle 3 arrives at the coffee shop 58, the driver hm receives the ordered coffee. In this case, the staff at the coffee shop may provide coffee in the store to the driver hm who has entered the store or may provide drive-through coffee to the driver hm sitting in the driver's seat.

In this manner, the vehicle control circuit 11 allows the driver to receive a product that is effective for improving his or her own condition while enforcing safe driving. In the related arts, when using a smartphone to provide products which are effective for the driver's condition, the driver has to start up the smartphone app and operate while staring at the touch panel with a small screen size, which takes time and effort to detect the driver's state and order products. The operation of the smartphone becomes a hindrance to safe driving. On the other hand, in the vehicle control circuit 11 of the present disclosure, the operation is simple without starting the application in advance. When the product recommended from the vehicle control circuit 11 is a regular order, the driver can obtain the recommended product with a single action of pressing a button. Therefore, even while the vehicle is travelling, the driver does not hinder driving.

The vehicle control circuit 11 can guide the vehicle on which the driver gets to a store which provides products or services recommended to the driver. On the store side, potential demand is aroused and the turnover rate of customers is improved, and further sales of goods or services can be expected to increase. It is also possible to return a part of the increase in the profit obtained at the store side to the side providing the vehicle control system 5.

Other Case 1

When detecting the drowsiness of the driver hm, the vehicle control circuit 11 may connect to the server 40 or the store terminal 50 via the network NW and obtain a digital coupon from the server 40 or the store terminal 50. In this case, the vehicle control circuit 11 outputs a voice message of “Would you like to order usual coffee? You can use the sandwich set coupon at the nearby coffee shop now”. When the driver hm pronounces “I will order”, the vehicle control circuit 11 obtains the result of the voice recognition, settles the order, and guides the driver hm along the traveling route to the coffee shop.

The store terminal 50 of the coffee shop 58 acquires the current position of the traveling vehicle 3 via the network NW and notifies the staff when the vehicle 3 approaches the store. The staff prepares hot coffee and a sandwich. When the vehicle 3 arrives at the coffee shop 58, the driver hm can receive hot coffee and a sandwich without waiting. The driver hm wakes up with coffee. As described above, the vehicle control circuit 11 can perform advance order and settlement using a coupon. On the store side, set sales with high customer unit prices can be expected.

Other Case 2

When the driver's condition is detected as having a cold, the vehicle control circuit 11 may recommend the driver to stop at a pharmacy or go straight to a hospital as a measure to improve the condition.

As described above, the vehicle control circuit 11 of the embodiment is mounted on the vehicle 3 on which the driver hm rides. The vehicle control circuit 11 (an example of the input unit) inputs the detection result of the driving state of the driver hm, for example, a captured image of a state in which the driver hm is drowsy, from the camera 21 mounted on the vehicle 3 and detecting the driving state of the driver hm. The vehicle control circuit 11 (an example of the recommendation processing unit) outputs the coffee mark mk2 (an example of recommendation data relating to use of a product or service), which is an image recommending coffee for improving the drowsiness of the driver hm, to the display circuit 15 mounted on the vehicle 3. The vehicle control circuit 11 (an example of the settlement processing unit) executes settlement processing for the corresponding coffee in response to an order input from the driver hm to the coffee mark mk2. The vehicle control circuit 11 (an example of the guidance processing unit) displays and guides the traveling route rt11 to the store mark sm (an example of the destination of use of the product or the service) representing the coffee shop on the display circuit 15 based on the completion of the settlement processing.

As a result, the vehicle control circuit 11 or the vehicle 3 can efficiently perform the processing necessary for using a product or service for adaptively improving the driver's state without hindering the driver's safe driving. As a result, the convenience of the driver during driving can be improved.

The vehicle control circuit 11 is connected to the storage unit 13 which records the recommendation table Tb1 indicating the correspondence relationship between the driving state of the driver hm and coffee recommended according to the state. The vehicle control circuit 11 generates the coffee mark mk2 which recommends coffee for improving the drowsiness of the driver hm corresponding to the detection result of the driving state of the driver hm based on the recommendation table Tb1. Therefore, the driver immediately knows what to do to improve the drowsiness.

The vehicle control circuit 11 records, in the purchase history table Tb2 stored in the storage unit 13, a purchase history in which the purchase and date and time (information about products or services) of the coffee that has been settled and the drowsiness state of the driver are associated with each other. The vehicle control circuit 11 generates the “usual” order button bt1 corresponding to the driver's drowsiness state based on the purchase history table Tb2 with priority over the recommendation table Tb1. Thus, the driver can easily order and settle the coffee with single action of simply pressing the “usual” order button bt1. Therefore, the driver can order coffee without hindering the driving operation, and thus the driver can drive safely.

The vehicle control circuit 11 as an example of the state notification unit notifies the driver hm of the detection result of the state of the driver hm via at least one of the display circuit 15 and the speaker 17. As a result, the driver can notice changes in his or her physical condition such as drowsiness and cold. The driver can drive according to his or her physical condition.

The vehicle control circuit 11 inputs, from the camera 21, information indicating that the driver hm is in a drowsiness state as a state based on the captured image of the driver hm. Thus, the vehicle control circuit 11 can recognize that the driver hm is in a drowsiness state based on the captured image. The vehicle control circuit 11 can immediately take a countermeasure when the driver hm is in a drowsiness state. Therefore, dangerous driving, in which the driver drives while sleeping, is avoided.

The vehicle control circuit 11 inputs information indicating that the driver hm is in a drowsiness state as a state based on the voice of the driver hm picked up by the microphone 22. Thereby, the vehicle control circuit 11 can recognize that the driver is in a drowsiness state based on the voice uttered by the driver. The vehicle control circuit 11 can immediately take a countermeasure when the driver is in a drowsiness state. Therefore, dangerous driving, in which the driver drives while sleeping, is avoided.

The vehicle control circuit 11 outputs drawing data of the drowsiness mark mk1 to the display circuit 15 connected to the vehicle control circuit 11 and causes the display circuit 15 to display the data. Therefore, the driver visually notices his or her drowsiness.

The vehicle control circuit 11 outputs voice data to the speaker 17 connected to the vehicle control circuit 11 and causes the speaker 17 to output a voice message of “Are you a little sleepy?”. Therefore, the driver aurally notices his or her drowsiness.

The vehicle control circuit 11 is connected to the storage unit 13 which stores the map DB 130 in which map data is registered (recorded). Using the map data registered in the map DB 130, the vehicle control circuit 11 guides the traveling route rt11 to the coffee shop (the destination of the use of the product or the service) that provides the coffee by image or voice using the navigation function. As a result, the driver hm can travel to the coffee shop according to the guided traveling route with the same feeling as car navigation that is commonly used. Therefore, the driver hm can perform safe driving.

Although the embodiments are described with reference to the drawings, it is needless to say that the present disclosure is not limited to such examples. It is obvious that those skilled in the art can conceive various changes, modifications, replacements, additions, deletions, and equivalents within the scope of the claims and it is naturally understood that those also belong to the technical scope of the present disclosure. The components in the embodiments described above may be arbitrarily combined without departing from the spirit of the invention.

For example, in the first embodiment described above, the vehicle control circuit 11 detects the state of the driver and provides a product or service for improving the state of the driver. However, a similar operation may be performed for a passenger in addition to the driver.

In the first embodiment described above, the driver orders the recommended product by touching the operation circuit with a finger. However, when the vehicle control circuit has a voice recognition function, a product may be ordered by voice input without performing a touch operation with a finger.

The present disclosure is useful as a vehicle control circuit, a vehicle, and a data input/output method which efficiently perform the processing necessary for using the product or service to adaptively improve the driver's state without hindering the driver's safe driving and improve the convenience of the driver while driving.

While various embodiments have been described herein above, it is to be appreciated that various changes in form and detail may be made without departing from the spirit and scope of the invention(s) presently or hereafter claimed.

This application is based on and claims priority from Japanese Patent Application No. 2019-055278 filed on Mar. 22, 2019, the entire contents of which are incorporated herein by reference.

1. A vehicle control circuit mountable on a vehicle on which a driver rides, the vehicle control circuit comprising:
an input unit configured to receive an input of a detection result of a state of the driver during driving from at least one sensor, the sensor being mounted on the vehicle and configured to detect the state;
a recommendation processing unit configured to output recommendation data to a notification device mounted on the vehicle, the recommendation data relating to use of a product or service for improving the state of the driver during driving indicated by the detection result;
a settlement processing unit configured to perform settlement processing for the use of the corresponding product or service in accordance with an input from the driver in response to the recommendation data; and
a guidance processing unit configured to provide a route to a destination of the use of the product or service based on completion of the settlement processing via the notification device.

2. The vehicle control circuit according to claim 1,
wherein the vehicle control circuit is connected to a recording unit which records a recommendation table indicating a correspondence relationship between the state of the driver during driving and the product or service recommended in accordance with the state, and
wherein the recommendation processing unit generates the recommendation data relating to the use of the product or service corresponding to the detection result based on the recommendation table.

3. The vehicle control circuit according to claim 2,
wherein the settlement processing unit records, in the recording unit, a purchase history in which information on the product or service subjected to the settlement processing is associated with the detection result, and
wherein the recommendation processing unit generates the recommendation data relating to the use of the product or service corresponding to the detection result based on the purchase history preferentially than the recommendation table.

4. The vehicle control circuit according to claim 1, further comprising:
a state notification unit which notifies the driver of the detection result of the state.

5. The vehicle control circuit according to claim 1,
wherein the input unit receives the input, from a camera serving as the sensor, information indicating that the driver is in a sleepy state as a state based on a captured image of the driver.

6. The vehicle control circuit according to claim 1,
wherein the input unit receives the input, from a microphone serving as the sensor, information indicating that the driver is in a sleepy state as a state based on voice of the driver.

7. The vehicle control circuit according to claim 1,
wherein the recommendation processing unit outputs the recommendation data to the notification device connected to the vehicle control circuit and causes the notification device to display the recommendation data.

8. The vehicle control circuit according to claim 1,
wherein the recommendation processing unit outputs the recommendation data to a speaker connected to the vehicle control circuit and causes the speaker to output a sound.

9. The vehicle control circuit according to claim 1,
wherein the vehicle control circuit is connected to a recording unit which records map data, and
wherein the guidance processing unit uses the map data to guide the route to the destination of the use of the product or service via an image or a voice.

10. A vehicle comprising:
a vehicle control circuit;
at least one sensor for detecting a state of a driver during driving; and
a notification device,
wherein the vehicle control circuit comprises:
an input unit configured to receive an input of a detection result of the state from the sensor,
a recommendation processing unit configured to output recommendation data to the notification device, the recommendation data relating to use of a product or service for improving the state of the driver during driving indicated by the detection result,
a settlement processing unit configured to perform settlement processing for the use of the corresponding product or service in accordance with an input from the driver in response to the recommendation data, and
a guidance processing unit configured to provide a route to a destination of the use of the product or service based on completion of the settlement processing via the notification device.

11. A data input/output method which is executed by a vehicle control circuit mountable on a vehicle on which a driver rides, the data input/output method comprising:
receiving an input of a detection result of a state of the driver during driving from at least one sensor, the sensor being mounted on the vehicle and configured to detect the state;
outputting recommendation data to a notification device mounted on the vehicle, the recommendation data relating to use of a product or service for improving the state of the driver during driving indicated by the detection result;
performing settlement processing for the use of the corresponding product or service in accordance with an input from the driver in response to the recommendation data; and
providing a route to a destination of the use of the product or service based on completion of the settlement processing via the notification device.
